(19) United States
(12) Patent Application Publication
(10) Pub. No.: US 2025/0363464 A1
(43) Pub. Date: Nov. 27, 2025

(54) TECHNICIAN PLANNING SYSTEM AND METHOD FOR REPAIRS AND MAINTENANCE OF AGRICULTURAL MACHINES

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Ray Ochsner, Papillion, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US)

(73) Assignee: CLAAS Omaha Inc., Omaha, NE (US)

(21) Appl. No.: 19/294,175

(22) Filed: Aug. 7, 2025

Related U.S. Application Data
(63) Continuation of application No. PCT/IB2023/061304, filed on Nov. 9, 2023.

(30) Foreign Application Priority Data
Feb. 9, 2023 (DE) 10 2023 103 208.9

(51) Int. Cl. G06Q 10/20; G06Q 10/0631; G06Q 50/02

(52) U.S. Cl. CPC G06Q 10/20; G06Q 10/063114; G06Q 50/02

(57) ABSTRACT

A technician planning method and system for planning agricultural machine technicians to plan and coordinate repairs and/or maintenance of agricultural machine. The technician planning method and system includes a server, a database, and the communication device. The server receives a customer problem from a customer communication device regarding the repair and/or maintenance of the agricultural machine. The customer problem initiates a delivery of a spare part and a technical service, with information being stored in the database concerning the location and/or the delivery possibilities of the spare part. The technician planning system is configured to determine at least one deployment planning of the agricultural machine technicians for the service order with respect to the technical service. The service order is derived from a definition of the customer problem and one or more planning criteria stored in the database with respect to the agricultural machine technicians.

### CROSS REFERENCE TO RELATED APPLICATION

This application is a bypass continuation and claims priority to PCT Application No. PCT/IB2023/061304 (published as WO/2024/165904) filed on Nov. 9, 2023, which claims priority to German Patent Application No. 10 2023 103 208.9 filed Feb. 9, 2023, the entire disclosure of both of which are hereby incorporated by reference herein. This application is also related to US application No. ______ (attorney docket no. 15191-24025A (P05768/8)), US application No. ______ (attorney docket no. 15191-24026A (P05769/8)), US application No. ______ (attorney docket no. 15191-24028A (P05771/8)), US application No. ______ (attorney docket no. 15191-24029A (P05772/8)), US application No. ______ (attorney docket no. 15191-24030A (P05773/8)), US application No. ______ (attorney docket no. 15191-24031A (P05774/8)), and US application No. ______ (attorney docket no. 15191-24032A (P05775/8)), each of which are incorporated by reference herein in their entirety.

### TECHNICAL FIELD

The present invention relates to a technician planning system and method for planning and coordinating one or both of repairs or maintenance of agricultural machines by agricultural machine technicians.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural machines form agricultural working machines for work-related use on agricultural fields and require technical services on a regular basis. These services may include maintenance and repair of worn or damaged components of the agricultural machine. Until now, this technical service has been performed at a maintenance site that is far away from the place of use of the agricultural machine. A customer may need to transport his/her agricultural machines needing such technical service to the maintenance location for an agricultural machine technician to first examine the agricultural machines, then order the necessary components and, after receiving these components, repair the agricultural machines.

In various regions, it may be time-consuming for the farmer to visit a dealer in order to receive services. It may be advantageous to the farmer if the service provider could come to the farmer and provide the desired service at the customer's premises. The farmer may need a wide range of services to perform his/her activities using agricultural machines. These services include, among others, regular maintenance of the machines, performing repairs, regular installation of software updates and managing the purchase of machines.

US Patent Application Publication No. 2024/0273643A1, incorporated by reference herein in its entirety, discloses a method in which the farmer communicates with a service provider and describes his/her problem, either concretely (need service “X”) or he/she formulates the problem visible to him/her. The service provider analyzes the problem and derives a possible solution. The realization of the solution (e.g., a repair) then sets a procedure in motion that is generally structured in such a way that the service provider operates a communication network that includes warehouses in which parts are stored, service trucks that are configured in such a way that they may perform repairs at the customer's premises and part runners that deliver parts from main warehouses to intermediate warehouses, to the customer, to the service truck, to transfer points and, if necessary, drones that also automatically perform spatially-limited delivery services. The method described in US Patent Application Publication No. 2024/0273643A1 operates in such a way that the service provider may ensure that the right parts and sufficient service personnel arrive at the customer's premises at a predefined time for the identified type of service, such as a repair. To do this, the service provider may use a logistics planning tool that procures the necessary parts from the various warehouses and delivers them to the customer and/or the service truck. The planning tool may also ensure that the service truck is equipped with the right tools and machines for the identified service. The planning tool may also be designed to recognize that the necessary repair may only be performed in a workshop. In this case, the service provider may arrange for the agricultural machine to be collected from the customer's premises and returned once the repair has been completed. In this case, the planning tool may also ensure that the workshop has the necessary parts and tools available.

### BRIEF DESCRIPTION OF THE DRAWING

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an example technician planning system for planning the deployment of one or more agricultural machine technicians in order to plan and coordinate repairs and/or maintenance of an agricultural machine of a customer.

### DETAILED DESCRIPTION

As discussed in the background, the performance of technical services at the place of use of an agricultural working machine may require that the service provider arrives at the place of use of the agricultural working machine to be serviced with the correct spare parts, with the correct tools to perform the service, and with sufficiently qualified service technician(s) to solve the service task given to him.

Thus, in one or some embodiments, a method and system are disclosed to provide a service which reduces or minimizes downtime of the agricultural machines to be serviced or repaired, and in which the repair or maintenance service is supported on site at the customer's premises by the correct agricultural machine technicians.

In one or some embodiments, the technician planning system is configured, such as trained and/or programmed, to determine at least one deployment planning of the agricultural machine technicians directed towards a service order. The service order may be derived from one or both of: a definition of a customer problem; and at least one or more planning criteria relating to the agricultural machine technician(s). In this case, the scheduling of the agricultural machine technician(s) may be planned and coordinated in such a way that these agricultural machine technician(s) perform the necessary repairs and/or maintenance at the place of use of the customer's agricultural machines in a way that improves or optimizes working time. The coordination of the agricultural machine technician(s) for the repairs and/or maintenance of the agricultural machines may take place via the communication device of the agricultural machine technician(s).

Thus, in one or some embodiments, the technician planning system may actively counteract possible downtimes of the agricultural machine with the optimal on-site deployment of the agricultural machine technician(s), so that the maintenance of an efficient and profitable agricultural operation is actively ensured. In particular, in one or some embodiments, any downtime that may occur may be less than or equal to 30 minutes.

In one or some embodiments, the agricultural machine may comprise a self-propelled combine harvester or a self-propelled forage harvester. Furthermore, the agricultural machine may be a tractor, such as with at least one implement or without an implement.

The customer who owns the agricultural machine may be a farmer who, for example, is positioned inside the agricultural machine, such as inside an operator's cab of the agricultural machine, or outside the agricultural machine during the reporting of the customer problem.

In one or some embodiments, the planning criteria comprise any one, any combination, or all of: qualifications of the agricultural machine technician(s); a number of agricultural machine technician(s); or one or more distances of the agricultural machine technician(s) to the customer-specific place of use.

The agricultural machine technician's qualifications may define any one, any combination, or all of his/her skills, his/her knowledge, or his/her behavioral patterns that enable the technician planning system to determine the optimal agricultural machine technician(s) for the service order when planning the operation. These skills and/or knowledge of the agricultural machine technician may refer to his/her repair technical experience regarding the type of agricultural machines to be repaired and/or maintained according to the service order.

The number of agricultural machine technician(s) may depend on the any one, any combination, or all of: the qualifications for the service order; the type of the service order; or the scope of the service order. The distances of the agricultural machine technician(s) to the customer-specific location may be determined in one of several ways, such as by using satellite-based position information of communication device of the agricultural machine technician(s) and satellite-based position information of communication device of the customer (e.g., a GPS receiver that generates a current location of the GPS receiver by receiving information from GPS satellites in order to calculate the device's geographical position). Communication device of the agricultural machine technician(s) and/or the customer may be mobile phones, tablets and/or computer systems, such as mobile computer systems (e.g., the GPS receiver may be resident in or associated with the mobile phones, tablets, and/or computer systems). Other determinations for the customer-specific location are contemplated.

The technician planning system may be configured to determine the optimal number of agricultural machine technician(s) depending on one or both of the qualifications of the agricultural machine technician(s) and the distances of the agricultural machine technician(s) to the customer-specific place of use and to coordinate these agricultural machine technician(s) using the deployment planning in such a way to reduce the time to on-site deployment (e.g., that the fastest and most perfect on-site deployment of the optimal agricultural machine technician(s) to the customer is ensured).

As discussed above, the customer problem may be defined by the specific issue (such as the specific technical problem) of the agricultural machine and a location of use of the customer's agricultural machine. Separate from this, in one or some embodiments, the customer problem may also comprise or be defined by any one, any combination, or all of: the type of agricultural machine; the type of components (or sub-components) of the agricultural machine; the operating age of the agricultural machine; the operating age components (or sub-components) of the agricultural machine; or the operating situation of the agricultural machine. This may further optimize the quicker or quickest on-site deployment of the appropriate agricultural machine technician(s).

In one or some embodiments, the technician planning system is configured to plan and coordinate an efficient order sequence of the agricultural machine technician(s) depending on the service order. In this case, it is envisaged that one or more agricultural machines technicians have to repair and/or service not only one agricultural machine of a customer, but several agricultural machineries of several customers at different locations on one day. In this case, the technician planning system may adapt the order sequence of the agricultural machine technician(s) in such a way that the several agricultural machineries of the several customers each receive an optimal on-site deployment of the agricultural machine technician(s).

In one or some embodiments, the technician planning system is configured to automatically assign jobs to the agricultural machine technicians and/or to suitably coordinate the agricultural machine technicians if more than one agricultural machine technician is required for the repair and/or maintenance of the agricultural machine. The orders may be automatically transmitted to communication device of the agricultural machine technicians and/or communication device of the customer. The automatic assignment of orders further optimizes the on-site deployment of the appropriate agricultural machine technician(s).

In one or some embodiments, the technician planning system is configured to automatically create a route plan for an agricultural machine technician from his/her current location to the place of deployment at the customer's premises during the deployment planning, and/or that the technician planning system is configured to enable the customer to automatically track the assigned agricultural machine technician(s). For example, the technician planning system may automatically create and load the route plan into a self-driving vehicle in order to automatically transport the agricultural machine technician from his/her current location to the place of deployment at the customer's premises according to the route plan created. This may improve the on-site deployment of the agricultural machine technician(s), and the customer may clearly and unambiguously automatically record when exactly the agricultural machine technician and/or the several agricultural machine technician(s) reach the agricultural machines and then repair and/or maintain it.

In one or some embodiments, the technician planning system is configured to automatically plan and coordinate the maintenance of agricultural machines and/or a service for the agricultural machines in a predictive manner, such as in a time-predictive manner, depending on the service order. In this anticipatory planning and coordination of the agricultural machine technician(s) regarding foreseeable maintenance work and/or services, these may be scheduled in such a way that this maintenance work and/or service is not performed during an operation of the agricultural machines, but either before or after, so that the agricultural operation of the agricultural machines is not affected. In this regard, the technician planning system may automatically determine the schedule of operation of the agricultural machines. In one or some embodiments, the technician planning system may receive (such as automatically receive) as input the schedule of the operation of the agricultural machines. Alternatively, or in addition, the technician planning system may automatically determine the schedule of the operation of the agricultural machines based on analysis of previous operations (e.g., previous operations of the agricultural machines subject to service or similarly situated agricultural machines). In this regard, the technician planning system may automatically determine the schedule as part of an overall automatic operation of the planning and the maintenance of agricultural machines and/or a service for the agricultural machines.

In one or some embodiments, the technician planning system is configured to improve or optimize the required working time of the agricultural machine technician(s) when planning the deployment of the agricultural machine technician(s) and/or to document the real working time of these agricultural machine technician(s) during the deployment of the agricultural machine technician(s). For example, to implement the improved or optimized required working time, the agricultural machine technician(s) may be transported via autonomous vehicles. The documentation of the real working times of these agricultural machine technician(s) depending on the service order may form the basic information for the optimal planning of the deployment of the agricultural machine technician(s). The real working times and/or averaged working times may be used to train an artificial intelligence (AI), such as artificial neural network(s), to determine the required working time of these agricultural machine technician(s) in advance, such as by using deep learning.

In one or some embodiments, the technician planning system is configured to automatically document repairs and/or maintenance and/or service work that has been performed by the agricultural machine technician(s) on the basis of the deployment planning. In this case, the documentation of the performance of the agricultural machine technician(s) may be used to automatically train an artificial intelligence, such as artificial neural network(s), in particular by means of deep learning, to determine the correct agricultural machine technician(s) in advance. In addition, the automatic documentation of the services of the agricultural machine technician(s) may be used to automatically generate the invoice for the work performed by the agricultural machine technician(s) on site at the customer.

In one or some embodiments, the technician planning system is configured to generate an automatic invoice and/or an automatic report, such as with regard to all orders, with regard to repairs and/or maintenance and/or service work performed by the agricultural machine technician(s) on the basis of the assignment planning. This invoice and/or report may be automatically transmitted to the communication device of the agricultural machine technician(s) and/or the communication device of the customer.

In one or some embodiments, the technician planning system is configured to automatically plan and coordinate the repairs and/or maintenance of agricultural machines in advance depending on the service order in such a way that the required spare parts and/or tools for the repair and/or maintenance of the agricultural machine are available at the customer's site at the latest at the same time as the assigned agricultural machine technician(s). For example, the transport of the spare parts and/or the tools for the repair and/or maintenance of the agricultural machine may be via drone and/or via self-driving vehicles. This may optimize the on-site deployment of the agricultural machine technician(s) in terms of time, as they do not have to wait for the required spare parts and/or tools. In this regard, the time planning of the customer and the agricultural machine technician(s) may be automatically aligned.

In one or some embodiments, the technician planning system comprises a computer-based server, a computer-readable database and a plurality of communication device. The server, the database and the communication device may be communicatively and/or electronically connected to one another in a communicating manner for the purpose of exchanging data via a communication network, such as by means of wireless and/or wired communication links. In one or some embodiments, the communication device may each be configured for this purpose, determine their respective position coordinates (e.g., using satellites) and transmit these determined position coordinates to the server and/or the database of the technician planning system. The server may be configured to automatically determine the deployment planning of the agricultural machine technician(s) directed towards the service order and to automatically coordinate the repair and/or maintenance of the customer's agricultural machines based thereon. The server of the technician planning system may automatically perform all necessary planning and coordination, so that, for example, the communication device may be relieved in terms of computing. The server may receive (such as automatically receive) a customer problem from the customer's communication device regarding the repair and/or maintenance of the agricultural machine. This customer problem may initiate a delivery (such as an automatic delivery) of the spare part and a technical service. In one or some embodiments, information regarding the location and the delivery possibilities of the spare part may be stored in the database.

In one or some embodiments, the server of the technician planning system is configured to automatically use the respective position coordinates of the agricultural machine technician(s) (e.g., using GPS coordinates of the communication device of the agricultural machine technician(s)) and the position coordinates of the customer (e.g., using GPS coordinates of the communication device of the customer) when automatically determining the deployment planning of the agricultural machine technician(s), in order to automatically determine the most optimal agricultural machine technician(s) with the smallest/shortest distance to the customer, and/or in that the server of the technician planning system is configured in order to automatically initiate corresponding controls of the communication device of the agricultural machine technician(s) and/or of the customer when coordinating the determined deployment planning. In turn, the respective GPS coordinates of the selected agricultural machine technician(s) and of the customer may be used in order to automatically generate respective routes, which may in turn be used by self-driving vehicles in order to automatically transport the selected agricultural machine technician(s) to the customer.

In one or some embodiments, these controls of the communication device may include that the communication device of the agricultural machine technician automatically initiating a route planning from his/her current location to the place of use at the customer and/or that the communication device of the agricultural machine technician and/or the customer automatically causes a tracking of the assigned agricultural machine technician(s).

In one or some embodiments, the technician planning system is configured to automatically present the repairs and/or maintenance of the agricultural machine in a comprehensible manner for a person responsible for the technician planning system and/or the customer, in which the invoice associated with the repair and/or maintenance is created in a time-optimized and transparent manner. This creation of the invoice may be fully automatic. A transparent invoice may mean that each cost center of the invoice is clearly and comprehensibly presented.

Thus, in one or some embodiments, qualified personnel may be automatically assigned in the right number so that the service may be accomplished in a quality-oriented manner. This may require that the problem be solved is described or identified in such a way that the appropriate technician or technicians may be selected. It may also play a role so that those specialists are selected who are appropriately qualified and are available as close as possible to the customer so that the service promise within a predetermined time period (e.g., within 30 minutes) may be fulfilled.

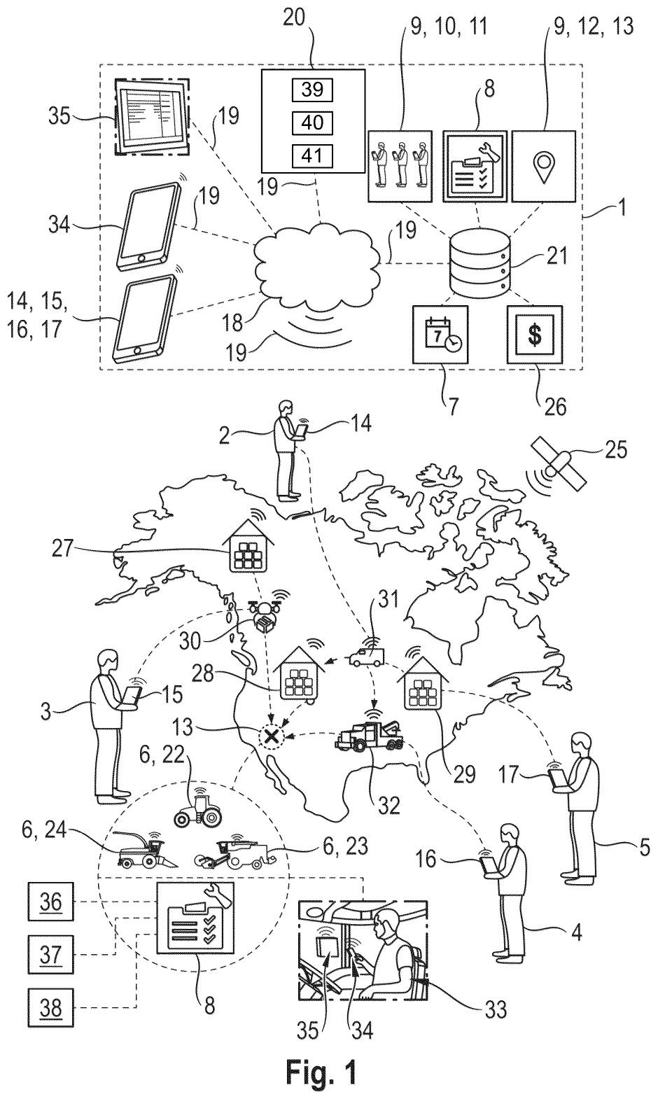

Referring to the figures, FIG. 1 illustrates an example of the technician planning system 1 for planning the deployment of one or more agricultural machine technician(s) 2, 3, 4, 5 in order to plan and coordinate repairs and/or maintenance of an agricultural machine 6 of a customer 33, who may be a farmer. This agricultural machine 6 of the customer 33 may be a self-propelled combine 23, a self-propelled forage harvester 24, or a tractor 22.

In one or some embodiments, the customer 33 may have his/her own communication device 34, which may comprise a smartphone, a table, or the like. Alternatively or additionally, a suitable means of communication 35 may be arranged or positioned in the agricultural machine 6, such as in a driver's cab of the agricultural machine 6, for the customer 33. This communication device 35 resident in or on the agricultural machine 6 may be designed as a driver assistance system, such as an electronic device (e.g., with computing functionality, discussed below) with a touch screen.

Various communication device are contemplated. As one example, communication device may comprise communication between an electronic device to a user, such as via an input and/or an output device (e.g., a display, a keyboard, a touchscreen, or the like). As another example, communication device may comprise a means by which to electronically communicate information between two electronic devices (e.g., via wired and/or wireless networks, via private or public networks, such as the Internet). The communication device 34 and/or 35 may be connected to a communication network 18 of the technician planning system 1 via a wired and/or wireless communication link, such as wireless communication link 19, for data transmission of a customer problem 8.

The agricultural machine technicians 2, 3, 4, 5 also each have their own communication device 14, 15, 16, 17, which may comprise an electronic communication device, such as a smartphone, a tablet, or the like (which may comprise computational functionality) and is connected to the communication network 18 of the technician planning system 1 via a wired and/or wireless network, such as wireless communication link 19, for data transmission, so that the agricultural machine technicians 2, 3, 4, 5 are optimally used during repairs and/or maintenance of the agricultural machine 6 of the customer 33. Other types of communication device 14, 15, 16, 17 are contemplated, such as smartphones, laptops, or other computing functionality.

In one or some embodiments, one agricultural machine technician 5 may be currently in a warehouse 29, while another agricultural machine technician 2 may be in a transport vehicle 31 to transport spare parts from warehouse 29 to warehouse 28. Still another agricultural machine technician 3 may be controlling a drone to transport required spare parts from warehouse 27. At the same time, still another agricultural machine technician 4 may be in a service vehicle 32 near the customer's service location 13. In this regard, the agricultural machine technicians 2, 3, 4, 5 may be performing various tasks as various locations within the system.

In one or some embodiments, the technician planning system 1 is configured to determine a deployment planning of the agricultural machine technicians 2, 3, 4, 5 directed towards a service order 7. The service order 7 may be derived from: a definition of the customer problem 8; and at least one or more planning criteria 9 relating to the agricultural machine technicians 2, 3, 4, 5. For this purpose, the technician planning system 1 is configured to automatically assign jobs to the agricultural machine technicians 2, 3, 4, 5 via the communication device 14, 15, 16, 17 and/or to suitably coordinate the agricultural machine technicians 2, 3, 4, 5 using the communication device 14, 15, 16, 17 if more than one agricultural machine technician 2, 3, 4, 5 is required for the repair and/or maintenance of the agricultural machine 6. Thus, the scheduling of the agricultural machine technicians 2, 3, 4, 5 may be automatically planned and coordinated in such a way that these agricultural machine technicians 2, 3, 4, 5 perform the necessary repairs and/or maintenance at the place of use (location 13) of the agricultural machine 6 of the customer 33 in a way that optimizes working time. This may actively counteract possible downtimes of the agricultural machine 6 with the optimal on-site deployment of the agricultural machine technicians 2, 3, 4, 5, so that the maintenance of the efficient and profitable agricultural operation is actively ensured.

As discussed above, the customer problem 8 may be defined as: the problem for the customer 33 as defined for the repair and/or maintenance of the agricultural machine 6; and a location of use (location 13) of the customer's agricultural machine 6. Separate from this, or instead of this, the customer problem 8 may be defined as any one, any combination, or all of: the type 36 of the agricultural machine 6; the type 36 of the components of the agricultural machine 6; the operating age 37 of the agricultural machine 6; the operating age 37 of the components of the agricultural machine 6; or the operating situation 38 of the agricultural machine 6.

In one or some embodiments, the technician planning system 1 may comprise, in addition to the communication device 14, 15, 16, 17, 34, 35, a server 20 and a database 21. The server 20 may comprise a hardware server and/or computer-based server, wherein the database 21 may be formed as an internal electronic memory of the server 20 and/or as an external electronic memory outside the server 20. The server 20 may be formed separately as well as spaced apart from the communication device 14, 15, 16, 17, 34, 35. In this case, the server 20 may receive the customer problem 8 from the customer-side communication device 34, 35 relating to the repair and/or maintenance of the agricultural machine 6. The customer problem 8 may automatically initiate the delivery of a spare part and the technical service, with the server 20 automatically accessing the database 21 for information relating to the location and delivery options of the spare part in order to automatically initiate the delivery of the spare part.

In one or some embodiments, the communication device 14, 15, 16, 17, 34, 35 may each be configured to determine their respective position coordinates, such as by using GPS receiver and communication with satellites 25, and to transmit these determined position coordinates to the server 20 and/or the database 21 of the technician planning system 1, the server 20 being configured to automatically coordinate the repair and/or maintenance of the agricultural machine 6 of the customer 33 based thereon. The distances of the agricultural machine technicians 2, 3, 4, 5 to the customer-specific operation site or location 13 may be automatically determined using the position information, such as the satellite-based position information, from the communication device 14, 15, 16, 17 of the agricultural machine technicians 2, 3, 4, 5 and the position information, such as the satellite-based position information, from the communication device 34, 35 of the customer 33. These communication device 14, 15, 16, 17, 34, 35 of the agricultural machine technicians and/or the customer may be mobile phones, tablets and/or computer systems, such as mobile computer systems. Other electronic devices and other types of positioning information are contemplated.

In one or some embodiments, the planning criteria 9 may include any one, any combination, or all of: the qualifications 10 of the agricultural machine technicians 2, 3, 4, 5 (e.g., for performing the repair and/or maintenance); the number 11 of agricultural machine technicians 2, 3, 4, 5 required for the repair and/or maintenance; or one or more distances 12 of these agricultural machine technicians 2, 3, 4, 5 with respect to the customer-specific place of use (location 13).

In one or some embodiments, the qualifications of an agricultural machine technician 2, 3, 4, 5 may comprise any one, any combination, or all of: his/her skills; his/her knowledge; or his/her behavioral patterns that enable the technician planning system 1 to automatically determine the optimal agricultural machine technician 2, 3, 4, 5 for the service order 7 when planning the deployment. These skills and/or knowledge of the agricultural machine technician 2, 3, 4, 5 may relate to his/her repair technical experience regarding the type 36 of agricultural machine 6 to be repaired and/or serviced according to the service order 7.

In one or some embodiments, the server 20 of the technician planning system 1 may be configured to record the work performed by the agricultural machine technician(s) 2, 3, 4, 5 at least partly during the commissioned repairs and/or maintenance of the agricultural machine 6, in order to continuously document and/or optimize the qualifications 10 of these agricultural machine technician(s) 2, 3, 4, 5 and/or the number 11 of agricultural machine technician(s) 2, 3, 4, 5 required, depending on the customer problem 8 and/or the place of use (location 13). In this regard, the technician planning system 1 may be configured to: automatically monitor in real-time and at interval(s) (such as predetermined intervals) the location and/or the activity of the agricultural machine technician(s) 2, 3, 4, 5 and/or the agricultural machine 6; responsive to the technician planning system 1 determining, based on the automatic monitoring in real-time and at interval(s) (such as predetermined intervals), that the agricultural machine technician(s) 2, 3, 4, 5 are performing repairs and/or maintenance on the agricultural machine 6, the technician planning system 1 records in real-time and at interval(s) (such as predetermined intervals) automatically records the documentation as to the work performed by the agricultural machine technician(s) 2, 3, 4, 5.

In one or some embodiments, the number of agricultural machine technicians 2, 3, 4, 5 may depend on the qualifications 10 and/or the type of service job 7 and/or the scope of the service job 7.

In one or some embodiments, the technician planning system 1 is configured to automatically determine the optimum number 11 of agricultural machine technicians 2, 3, 4, 5 depending on one or both of: the qualifications 10 of the agricultural machine technicians 2, 3, 4, 5; and the distances 12 of the agricultural machine technicians 2, 3, 4, 5 to the customer-specific deployment site 13. The technician planning system 1 may further be configured to automatically coordinate these agricultural machine technicians 2, 3, 4, 5 using the deployment planning in such a way to reduce wasted time may be ensured (e.g., that the fastest possible and perfect on-site deployment of the optimum agricultural machine technicians 2, 3, 4, 5 at the customer 33).

In one or some embodiments, the technician planning system 1 automatically plans and coordinates the required number of agricultural machine technicians 2, 3, 4, 5 depending on the service order 7 according to an efficient order sequence. For example, the routing of the spare parts and/or the tools and/or the technicians may be performed autonomously (e.g., via drone and/or self-driving vehicle) in the efficient order sequence. During this automatic job planning, a route plan for the agricultural machine technicians 2, 3, 4, 5 from its current location to the job site or location 13 at the customer 33 may be automatically provided.

In one or some embodiments, the technician planning system 1 is configured to automatically plan and coordinate the repairs and/or maintenance of the agricultural machines 6 in advance depending on the service order 7 in such a way that the necessary spare parts and/or tools for the repair and/or maintenance of the agricultural machines 6 are available at the customer 33 at the latest at the same time as the assigned agricultural machine technician 4 at the place of use (location 13). Merely by way of example, the automatic coordinating of the spare parts and/or tools and/or technicians may be performed via drone and/or self-driving vehicles.

In this case, the work planning and route planning of the agricultural machine technician 2, who drives the transport vehicle 31 (or who is automatically driven via a driverless vehicle or self-driving vehicle) and is tasked with collecting a required spare part from the warehouse 28, may be optimally linked with the route planning of the agricultural machine technician 4, who drives the service vehicle 32 (or who is automatically driven via a driverless vehicle or self-driving vehicle), in such a way that the required spare part arrives at the customer's 33 place of use (location 13) at the same time (or within no more than a predetermined amount of time, such as no more than 5 minutes, no more than 10 minutes, no more than 15 minutes, etc.) as the tasked agricultural machine technician 4.

In addition, the technician planning system 1 may be configured to automatically document the real working time of the agricultural machine technicians 2, 3, 4, 5 during the deployment of the agricultural machine technicians 2, 3, 4, 5 in order to present the repairs and/or maintenance of the agricultural machines 6 to a person in charge of the technician planning system 1 and/or the customer 33 in a comprehensible and comprehensive manner, in which the invoice 26 associated with the repair and/or maintenance is automatically created in a time-optimized (e.g., at a predetermined time) and/or transparent manner.

The digital service module 3, and with it the success guarantee management system 4, may be hosted on a server 5 with a database 6. The server 5 may comprise computing and communication functionality, such as it may include at least one processor 39, at least one memory 40, and at least one communication interface 41. The at least one processor 39 and at least one memory 40 may be in communication (e.g., wired and/or wirelessly) with one another. In one or some embodiments, the processor 39 may comprise a microprocessor, controller, PLA, or the like. Similarly, the memory 40 may comprise any type of storage device (e.g., any type of memory). Though the processor 39 and the memory 40 are depicted as separate elements, they may be part of a single machine, which includes a microprocessor (or other type of controller) and a memory. Alternatively, the processor 39 may rely on the memory 40 for all of its memory needs. Still alternatively, the processor 39 may rely on a database (such as database 21) for some or all of its memory needs.

The memory 40 may comprise a tangible computer-readable medium that include software that, when executed by the processor 39 is configured to perform any one, any combination, or all of the functionality described herein, such as one or more parts of the digital service module 3. In this regard, any functionality described herein, such as (without limitation) with regard to the technician planning system 1, the agricultural machine 6, tractor 22, combine harvester 23, forage harvester 24, drone 30, vehicle 31, or service vehicle 32 may use the computing functionality described herein, such as the processor 39, the memory 40 and/or the communication interface 41.

Further, the communication interface 41 may be configured to communicate (e.g., wired and/or wirelessly) with one or more electronic devices. As one example, any one, any combination, or all of the following may communicate with one another via its respective communication interface 41: the technician planning system 1, the agricultural machine 6, tractor 22, combine harvester 23, forage harvester 24, drone 30, vehicle 31, or service vehicle 32.

The processor 39 and the memory 40 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Technician planning system
2 Agricultural machine technician
3 Agricultural machine technician
4 Agricultural machine technician
5 Agricultural machine technician
6 Agricultural machine
7 Service order
8 Customer problem
9 Planning criterion
10 Qualification
11 Number of agricultural machine technicians
12 Distance
13 Location
14 Communication device
15 Communication device
16 Communication device
17 Communication device
18 Communications network
19 Wireless or wired communication link
20 Server
21 Database
22 Tractor
23 Self-propelled combine harvester
24 Self-propelled forage harvester
25 Satellite
26 Invoice
27 Warehouse
28 Warehouse
29 Warehouse
30 Drone (e.g., autonomous drone) as spare parts carrier
31 Vehicle (e.g., autonomous vehicle) as spare parts carrier
32 Service vehicle
33 Customer, especially farmer
34 Means of communication of the farmer
35 Means of communication of the agricultural machine
36 Type of agricultural machine and/or components of the agricultural machine
37 Operating age of the agricultural machine and/or components of the agricultural machine
38 Operating situation of the agricultural machine
39 Processor
40 Memory
41 Communication interface

1. A technician planning system configured to automatically plan and automatically coordinate one or both repair or maintenance of agricultural machines by agricultural machine technicians, the technician planning system comprising:
at least one server;
at least one database configured to store information regarding one or both of location or delivery possibilities of a spare part; and
a plurality of communication devices;
wherein the at least one server, the at least one database and the plurality of communication devices are communicatively connected to each other for data exchange via a communication network;
wherein the at least one server is configured to:
receive a customer problem from one of the plurality of communication devices regarding the one or both repair or maintenance of the agricultural machine;
responsive to receiving the customer problem, automatically initiate a delivery of a spare part and a technical service;
automatically derive a service order from a definition of the customer problem and at least one or more planning criteria stored in the database with regard to the agricultural machine technicians; and
automatically determine at least one deployment planning of one or more agricultural machine technicians for the service order with regard to the technical service.

2. The technician planning system of claim 1, wherein the one or more planning criteria comprise one or more of: qualifications of the agricultural machine technicians; a number of the agricultural machine technicians; or one or more distances of the agricultural machine technicians to a customer-specific place of use at which to solve the customer problem.

3. The technician planning system of claim 1, wherein the one or more planning criteria comprise each of: qualifications of the agricultural machine technicians; a number of the agricultural machine technicians; and one or more distances of the agricultural machine technicians to a customer-specific place of use at which to solve the customer problem.

4. The technician planning system of claim 1, wherein the customer problem comprises a problem of the customer, a place of use of the agricultural machine of the customer, one or both of a type of the agricultural machine or its components, one or both of an operating age of the agricultural machine or its components, and an operating situation of the agricultural machine.

5. The technician planning system of claim 1, wherein the at least one server is configured to automatically plan and coordinate an efficient order sequence of the agricultural machine technicians depending on the service order.

6. The technician planning system of claim 1, wherein the at least one server is configured to:
automatically determine whether a plurality of the agricultural machine technicians are needed to solve the customer problem; and
responsive to determining that the plurality of the agricultural machine technicians are needed, perform one or both of:
automatically assign jobs to the plurality of the agricultural machine technicians to perform one or both of the repair or the maintenance of the agricultural machine; or
automatically coordinate the plurality of the agricultural machine technicians to perform one or both of the repair or the maintenance of the agricultural machine.

7. The technician planning system of claim 1, wherein the at least one server is configured to:
automatically generate a route plan for a respective agricultural machine technician from a current location to a place of deployment at the customer during deployment planning; or
automatically enable the customer to track the respective agricultural machine technician assigned.

8. The technician planning system of claim 1, wherein the at least one server is configured to:
automatically generate a route plan for a respective agricultural machine technician from a current location to a place of deployment at the customer during deployment planning; and
automatically enable the customer to track the respective agricultural machine technician assigned.

9. The technician planning system of claim 1, wherein the at least one server is configured to:
receive a service order; and
responsive to receiving the service order, automatically plan and coordinate one or both of the maintenance of the agricultural machine or the service of the agricultural machine.

10. The technician planning system of claim 1, wherein the at least one server is configured to:
automatically optimize a required working time of the one or more agricultural machine technicians when planning deployment of the one or more agricultural machine technicians; or
automatically document real-time working of the one or more agricultural machine technicians during the deployment of the one or more agricultural machine technicians.

11. The technician planning system of claim 1, wherein the at least one server is configured to:
automatically optimize a required working time of the one or more agricultural machine technicians when planning deployment of the one or more agricultural machine technicians; and
automatically document real-time working of the one or more agricultural machine technicians during the deployment of the one or more agricultural machine technicians.

12. The technician planning system of claim 1, wherein the at least one server is configured to:
automatically document one or more of repairs, maintenance, or service work performed responsive to assignment planning of the one or more agricultural machine technicians.

13. The technician planning system of claim 1, wherein the at least one server is configured to:
automatically generate one or both of invoicing or reporting with regard to one or more of repairs, maintenance, or service work performed by the one or more agricultural machine technicians responsive to assignment planning.

14. The technician planning system of claim 1, wherein the at least one server is configured to:
responsive to the service order, automatically command transport of one or both of spare parts or tools for the one or both of the repair or maintenance of the agricultural machine so that the spare parts or tools are available at least at a same time as a respectively assigned agricultural machine technician is at a place of use of the agricultural machine.

15. The technician planning system of claim 1, wherein the plurality of communication devices include a GPS receiver in order to automatically generate a respective position and to automatically transmit the respective position to one or both of the at least one server or the at least one database; and
wherein the at least one server is configured, based on the respective positions of the plurality of communication devices, to automatically determine the deployment planning of the one or more agricultural machine technicians assigned to the service order and to automatically coordinate the one or both of the repair or the maintenance of the agricultural machine of the customer based thereon.

16. The technician planning system of claim 15, wherein the at least one server is configured to:
automatically use the respective positions of the plurality of communication devices of the one or more agricultural machine technicians and of the customer when automatically determining the deployment planning of the one or more agricultural machine technicians in order to determine an optimal set of agricultural machine technicians with a smallest distance from the customer; or
automatically initiate corresponding controls of the plurality of communication devices of one or both of the agricultural machine technicians and of the customer when coordinating the determined operational planning.

17. The technician planning system of claim 15, wherein the at least one server is configured to:
automatically use the respective positions of the plurality of communication devices of the one or more agricultural machine technicians and of the customer when automatically determining the deployment planning of the one or more agricultural machine technicians in order to determine an optimal set of agricultural machine technicians with a smallest distance from the customer; and
automatically initiate corresponding controls of the plurality of communication devices of one or both of the one or more agricultural machine technicians and of the customer when coordinating the determined operational planning.

18. The technician planning system of claim 1, wherein the one or more planning criteria comprise one or more of: qualifications of the agricultural machine technicians; a number of the agricultural machine technicians; or one or more distances of the agricultural machine technicians to a customer-specific place of use at which to solve the customer problem; and
wherein the at least one server is configured to:
automatically record work performed by the one or more agricultural machine technicians during the one or both of the repair or the maintenance of the agricultural machine in order to one or both of: dynamically document; or optimize qualifications of the agricultural machine technicians or optimize a number of the agricultural machine technicians assigned as a function of one or both of the customer problem or a place of deployment.

19. The technician planning system of claim 1, wherein the technician planning system is further configured to automatically present the one or both of the repairs or the maintenance of the agricultural machine and to automatically produce an invoice associated with the one or both of the repair and the maintenance in a time-optimized or transparent manner.
